(19) United States
(12) Patent Application Publication
(10) Pub. No.: US 2025/0380102 A1
(43) Pub. Date: Dec. 11, 2025

(54) SPATIAL AUDIO RENDERING OF VEHICLE SOUNDS IN A VEHICLE INTERIOR

(71) Applicant: HARMAN BECKER AUTOMOTIVE SYSTEMS GmbH, Karlsbad-Ittersbach (DE)

(72) Inventor: Marcel Pilgaard HAVEMANN, Hjerm (DK)

(21) Appl. No.: 19/207,838

(22) Filed: May 14, 2025

Related U.S. Application Data
(60) Provisional application No. 63/656,325, filed on Jun. 5, 2024.

(51) Int. Cl. H04S 7/00

(52) U.S. Cl. CPC H04S 7/30

(57) ABSTRACT

In various embodiments, a computer-implemented method for reproducing a simulated soundscape within a first vehicle, comprises receiving selection of the simulated soundscape within a vehicle cabin associated with the first vehicle, receiving a sensor input associated with the first vehicle, identifying a soundscape element based on the selected simulated soundscape, determining a sound corresponding to the soundscape element based on the sensor input, determining a location within the cabin of the plurality of sounds based on the selected simulated soundscape, and causing playback of the sound within the vehicle cabin based on the location.

### CROSS-REFERENCE TO RELATED APPLICATIONS

This application claims the priority benefit of U.S. Provisional Application No. 63/656,325, filed Jun. 5, 2024, and entitled “SPATIAL AUDIO RENDERING OF VEHICLE SOUNDS IN A VEHICLE INTERIOR”, the contents of which are incorporated by reference herein in its entirety.

### BACKGROUND

### Field of the Various Embodiments

The present disclosure relates to the field of audio systems, and more particularly to spatial audio rendering of vehicle sounds in a vehicle interior.

### Description of the Related Art

Some modern vehicles, such as electrical vehicles (EVs), vehicle simulators, and internal combustion engine (ICE) vehicles, do not produce a distinct soundscape during operation, creating an unengaging driving experience for the user. In contrast, a user in a combustion vehicle can typically experience a wide range of sounds influenced by various factors, including engine load, wind resistance, road surface conditions, engine revolutions-per-minute (RPM) levels, acceleration, changes in elevation, and other factors. Therefore, simulating sounds associated with a conventional combustion engine vehicle can improve the driving experience of users in vehicles or vehicle simulators that do not have an engaging soundscape.

One drawback of conventional methods of audio rendering of vehicle sounds in a vehicle interior is the static nature of sound delivery. Conventional methods of audio rendering of vehicle sounds in a vehicle interior often rely on sounds delivered in unison through speakers that result in a flat and unconvincing soundscape. Additionally, conventional methods do not account for the complex, dynamic soundscape of a combustion engine vehicle cabin that changes with speed, acceleration, wheel RPM, and other aspects of the environment of the vehicle. Furthermore, conventional methods fail to account for the wide range of sounds that may appear from varying spatial locations with respect to the user depending on the construction of the combustion vehicle. Conventional methods are limited in the ability to reproduce spatial and dynamic characteristics of an immersive soundscape, resulting in a less realistic and less engaging soundscape. Another drawback of conventional methods is the limited ability to allow for the customization of the soundscape. Systems associated with conventional methods may not allow users to customize the soundscape to match different types of pre-configured combustion engine vehicles or to selectively reduce specific sound attributes (e.g., tire noise) that may be undesirable.

Therefore, there is a need for improved methods of playback of vehicle sounds in a vehicle interior to create a more immersive experience relative to conventional methods in the art.

### SUMMARY

In various embodiments, a computer-implemented method for reproducing a simulated soundscape within a first vehicle, comprises receiving selection of the simulated soundscape within a vehicle cabin associated with the first vehicle, receiving a sensor input associated with the first vehicle, identifying a soundscape element based on the selected simulated soundscape, determining a sound corresponding to the soundscape element based on the sensor input, determining a location within the cabin of the plurality of sounds based on the selected simulated soundscape, and causing playback of the sound within the vehicle cabin based on the location.

Further embodiments provide, among other things, one or more non-transitory computer-readable media and systems configured to implement the method set forth above.

At least one technical advantage of the disclosed techniques, relative to the prior art, is that the disclosed techniques provide a more realistic soundscape that recreates the various sounds generated by a combustion engine vehicle. The disclosed techniques further account for the directional and positional differences in the soundscape in different parts of a vehicle cabin. In addition, the disclosed techniques enable the user to interact with a user interface and select a preconfigured soundscape that mimics the experience of driving different combustion engine vehicles. The disclosed techniques also allow for the type of combustion engine vehicle to simulate to be dynamically changed, allowing the user to selectively control which type of combustion engine vehicle to mimic. Another technical advantage of the disclosed techniques is the ability to customize the soundscape to allow specific audio attributes to be selectively enhanced, reduced, or removed entirely, thereby tailoring the audio output to the desired experience of the user. These technical advantages provide one or more technological improvements over prior art approaches.

### BRIEF DESCRIPTION OF THE DRAWINGS

In order to more clearly illustrate the technical solutions of the embodiments of the present disclosure, the accompanying drawings to be used in the description of the embodiments will be briefly introduced below, and it will be obvious that the accompanying drawings in the following description are only some of the embodiments of the present disclosure, and that for those of ordinary skill in the art, other accompanying drawings can be obtained based on these drawings without making creative labor. The following accompanying drawings are not intentionally drawn in equal proportions to the actual dimensions.

FIG. 1 illustrates a schematic diagram of a system according to various embodiments;

FIG. 2A and FIG. 2B illustrate examples of combustion vehicle soundscapes according to various embodiments; and

FIG. 3 illustrates a flow diagram of method steps for spatial audio rendering of vehicle sounds in a vehicle interior according to various embodiments.

### DETAILED DESCRIPTION

In the following description, numerous specific details are set forth to provide a more thorough understanding of various embodiments. However, it will be apparent to those skilled in the art that inventive concepts may be practiced without some or all of these specific details.

### System Overview

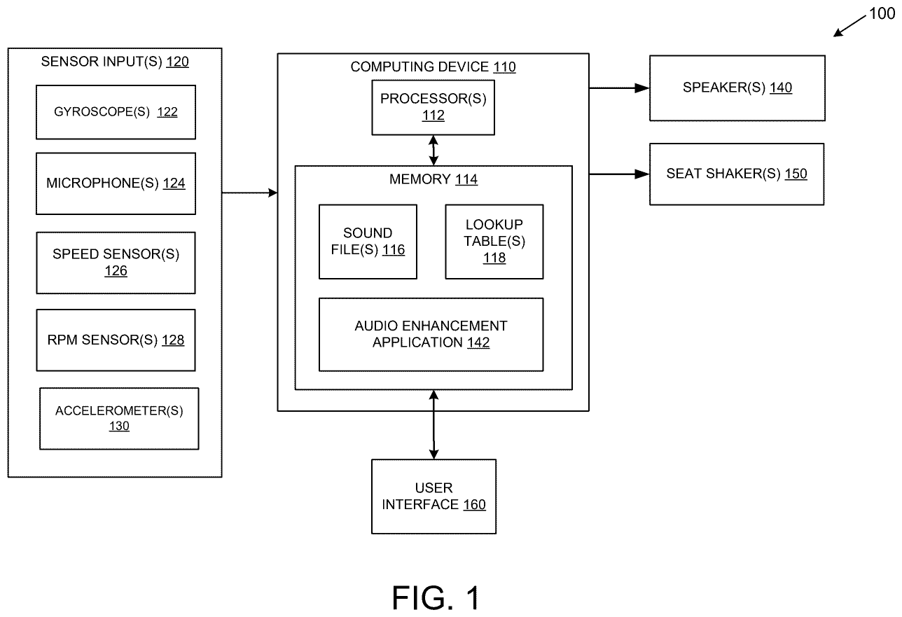

FIG. 1 is a schematic diagram of a system 100 according to various embodiments. As shown, system 100 includes, without limitation, sensor inputs 120, a computing device 110, speakers 140, seat shakers 150, and a user interface 160. Sensor inputs 120 include gyroscopes 122, microphones 124, speed sensors 126, RPM sensors 128, accelerometers 130, and other sensors. The computing device 110 includes, without limitation, processors 112 and a memory 114. The memory 114 includes sound files 116, lookup tables 118, and audio enhancement application 142. The audio enhancement application 142 interfaces with user interface 160, speakers 140, and seat shakers 150.

In some embodiments, computing device 110 is included in one or more devices, such as consumer products (e.g., portable speakers, gaming consoles, entertainment systems, etc.), vehicles (e.g., the head unit of a car, truck, van, bus, train, airplane, or other vehicle), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), computers, and so forth.

Processors 112 controls the overall operation of computing device 110. Processors 112 are configured to read and write data from memory 114. Processors 112 can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, Processors 112 can be any technically feasible hardware unit capable of processing data, executing instructions, and/or performing signal processing tasks, such as the signal processing task of manipulating sound files 116.

Memory 114 can include a random-access memory (RAM) module, a flash memory unit, or any other type of memory unit or combination thereof. The processors 112 are configured to read data from and write data to memory 114. In various embodiments, memory 114 includes non-volatile memory, such as optical drives, magnetic drives, flash drives, or other storage. In some embodiments, separate data stores, such as an external data stores (not shown) included in a network (“cloud storage”) can supplement the memory 114. The audio enhancement application 142 within memory 114 can be executed by the computing device 110 to implement the overall functionality of the computing device 110 and, thus, to coordinate the operation of the system 100.

Sound files 116 can be stored in memory 114. In some implementations, sound files 116 are stored in any technically feasible data storage location, including off-board systems such as remote servers. Storage of sound files 116 is not limited to physical memory located within computing device 110. Sound files 116 can include any feasible sound produced by or in-part by a combustion vehicle, including sounds associated with specific makes and models of combustion vehicles. Sound files 116 include, but are not limited to, a library of sounds associated with a simulated soundscape, such as aerodynamic noise generated as a vehicle moves through wind, road noise caused by engagement with a road or road surface, and mechanical noises produced by various vehicle components. Further examples include, motor sounds, gear engagement sounds, engine whirring while stationary or moving, fuel injection sounds, engine RPM variations, exhaust system sounds, engine vibration, wheel rotation sounds, wheel screeching, wheel spin, gear shifting, hard acceleration sounds, calm cruising sounds, speed-related sounds, and engine squealing. Sound files 116 also include any additional sounds required to recreate the full acoustic soundscape of a combustion vehicle as it operates and interacts with the environment, as further discussed below.

Lookup tables 118 store data associated with conventional combustion vehicle behavior and are used to map sensor input data to corresponding audio outputs. For example, audio enhancement application 142 identifies a sound file 116 using one or more of the lookup tables 118 based on a degree of vehicle motion or acceleration indicated by sensor inputs 120. In some embodiments, the use of lookup tables 118 includes identifying gearshift points. For example, when simulating a specific combustion vehicle soundscape, lookup tables 118 identify the RPM threshold at which a transition occurs between gears, such as from first gear to second gear. When simulated engine RPM sounds reach an RPM threshold stored in lookup tables 118, the corresponding gearshift sound is triggered. Lookup tables 118 can also store information related to audio characteristics with various driving modes, including performance mode, sport mode, eco mode, or any other technically feasible operational mode of the vehicle being simulated. In each case, specific sound profiles and transition thresholds are stored within lookup tables 118 to reflect the behavior of the selected mode. In additional examples, lookup tables 118 include mappings for scenarios such as engine acceleration, where the rate of fuel input can correspond to a specific engine sound or vibration pattern. Lookup tables 118 can also store parameters associated with engine load, throttle response, torque curves, deceleration behavior, idle behavior, or response to environmental conditions such as incline or terrain type. Lookup tables 118 enable the system 100 to simulate detailed vehicle behavior by providing reference mappings between sensor data and corresponding audio or vibrational output based on combustion vehicle characteristics.

Sensor inputs 120 can include any technically feasible sensor capable of providing data usable for simulating a vehicle sound. For example, sensor inputs 120 can include, without limitation, gyroscopes 122, microphones 124, speed sensors 126, RPM sensors 128, accelerometers 130, and other sensors. The sensor inputs 120 can also include additional technically feasible sensors not specifically discussed, such as cameras, lidar sensors, temperature sensors, barometric sensors, moisture sensors, and so on. Audio enhancement application 142 controls the audio processing workflow, using data from the sensor inputs 120 and one or more selections made by the user using user interface 160, to generate a soundscape within the cabin. Audio enhancement application 142 enables the user to select a specific combustion vehicle sound for simulation via user interface 160. Then, audio enhancement application records real-time data using sensor inputs 120. Utilizing processors 112, audio enhancement application 142 processes sensor inputs 120, based on techniques discussed further in detail below. Based on sensor inputs 120 and lookup table 118, audio enhancement application 142 selects and modifies sound files 116. Audio enhancement application 142 outputs sound files 116 to speakers 140 for playback within a vehicle cabin. Audio enhancement application 142 also activates seat shakers 150 based on processed data when vibration is required to simulate a selected soundscape.

Audio enhancement application 142 creates soundscapes with spatial accuracy using a spatial arrangement of speakers 140. For a simulated vehicle, audio enhancement application 142 directs specific audio sources to designated speakers 140 based on physical location. For example, engine noise can originate from front-mounted speakers 140, exhaust rumble can originate from rear-mounted speakers 140, and ambient wind sounds can originate from side-mounted speakers 140. Audio enhancement application 142 spatially maps sound files 116 to speakers 140 to create immersive in-cabin soundscapes.

Audio enhancement application 142 can dynamically manipulate sound files 116 in real time to adjust, without limitation, pitch, volume, tone, and/or other audio parameters. Audio enhancement application 142 can apply modulation algorithms to overlay multiple sound files 116, blend environmental effects, and/or introduce dynamic filters based on sensor inputs 120. Audio enhancement application 142 enables adaptive audio responses that reflect changing vehicle conditions and user preferences.

Audio enhancement application 142 uses a variety of sensor inputs 120 to manipulate and play sound files 116. For example, audio enhancement application 142 can use inputs from gyroscopes 122 to detect vehicle rotation along multiple axes and identify changes in rotational movement or orientation. Audio enhancement application 142 uses data from gyroscopes 122 to enable dynamic adjustment of spatial audio output through speakers 140, aligning directional sound effects with vehicle orientation during events such as turning, banking, or cornering.

Audio enhancement application 142 uses microphones 124 to capture acoustic data from both interior and exterior environments. Audio enhancement application 142 uses the captured audio to apply noise cancellation, removing unwanted environmental noise such as wind or road sounds, and enabling replacement with sound files 116 that simulate desired internal combustion engine vehicle acoustics.

Audio enhancement application 142 uses speed sensors 126 to measure real-time vehicle velocity and detect changes in speed. Audio enhancement application 142 can use speed data to modulate, without limitation, the playback intensity, pitch, and frequency of sound files 116, simulating variations in engine behavior, aerodynamic noise, and road surface interaction as the vehicle accelerates or decelerates.

Audio enhancement application 142 can use inputs from RPM sensors 128 to track revolutions-per-minute of an electric motor, engine or wheels. Audio enhancement application 142 compares RPM data against thresholds in lookup tables 118 to identify operational states such as gear shifting or throttle changes. Audio enhancement application 142 selects corresponding sound files 116 and plays corresponding sound files 116 to simulate internal combustion engine performance.

Audio enhancement application 142 can use inputs from accelerometers 130 to detect acceleration of the vehicle. Audio enhancement application 142 uses acceleration data to trigger adjustments in the playback of sound files 116, such as increasing engine aggressiveness or RPM during rapid acceleration or introducing braking effects during deceleration. Accelerometer data can also support activation of seat shakers 150 to deliver physical feedback that matches the simulated driving conditions.

Audio enhancement application 142 can also include selectable operation modes that influence the character of the simulated soundscape. Example modes include, without limitation, comfort, eco, sport, off-road, or track. Each mode can define a unique set of parameters stored in lookup tables 118. Audio enhancement application 142 uses the selected mode to adjust sound file 116 selection, playback intensity, spatial characteristics, and frequency emphasis. For example, in sport mode, audio enhancement application 142 can play an aggressive engine growl, amplified gearshift sounds, and enhanced vibration via seat shakers 150. In contrast, comfort mode triggers smoother transitions, dampened engine noise, and limited physical feedback. Audio enhancement application 142 can receive selection input via user interface 160.

Various soundscape elements can be recreated using audio enhancement application 142. In one embodiment, audio enhancement application 142 can detect hill ascent and descent using accelerometers 130 and gyroscopes 122. Audio enhancement application 142 identifies vehicle orientation changes when traveling uphill, downhill, on a camber, or through a curve. Audio enhancement application 142 retrieves and plays corresponding sound files 116 for engine load variations, wind noise changes, and road surface interaction in response to detecting vehicle orientation changes.

Audio enhancement application 142 can use input from pedal position sensors to detect the degree of depression of the accelerator pedal and/or the brake pedal. Audio enhancement application 142 can use the degree of depression to determine the driving behavior of the user, such as aggressive acceleration or gradual braking. In response to accelerator input, audio enhancement application 142 modulates sound files 116 to increase engine intensity, turbocharger whine, gearshift sensations, or other vehicle dynamics. In response to brake input, audio enhancement application 142 can play deceleration sounds, downshifting tones, or engine braking sound effects. Pedal position data can also be used to coordinate seat shaker 150 activation during hard braking or acceleration events.

In some embodiments, audio enhancement application 142 recreates fuel injection sounds based on data from lookup tables 118 and data from RPM sensors 128. In response to detecting conditions indicative of fuel delivery, such as rapid increases in engine revolutions or throttle input, audio enhancement application 142 triggers playback of high-frequency injector clicks and intake sounds from sound files 116 to reflect fuel delivery dynamics.

In some embodiments, audio enhancement application 142 detects high-speed vehicle operation using speed sensors 126 and RPM sensors 128. In response to speed and RPM data exceeding predefined thresholds in lookup tables 118, audio enhancement application 142 selects and plays sound files 116 with intensified engine roar, aerodynamic wind rush, and transmission whine to simulate elevated vehicle velocity.

In some embodiments, audio enhancement application 142 detects uneven traction scenarios using RPM sensors 128 and accelerometers 130. In response to detecting loss of traction or rapid changes in acceleration, audio enhancement application 142 activates seat shakers 150 to generate vibration patterns simulating wheel slip, gravel impact, or surface irregularities. Additionally, audio enhancement application 142 causes speakers 140 to play sound files 116 corresponding to tire squeal, or gravel crunch.

In some embodiments, audio enhancement application 142 can detect vehicle cornering behavior using accelerometers 130, gyroscopes 122 and/or speed sensors 126. In response to changes in angular velocity and lateral movement, audio enhancement application 142 modulates sound files 116 to emphasize differential engine load and tire scrub sounds. Audio enhancement application 142 activates seat shakers 150 to deliver lateral vibration feedback simulating cornering forces.

In some embodiments, audio enhancement application 142 uses microphone 124 to capture exterior acoustic data, including wind noise, road surface noise, and ambient environmental sounds outside the cabin. In response to detecting unwanted noise signatures, audio enhancement application 142 applies noise cancellation algorithms to attenuate unwanted noise. Concurrently, audio enhancement application 142 overlays sound files 116 simulating internal combustion vehicle characteristics such as tailpipe resonance, engine roar, or intake resonance.

In some embodiments, audio enhancement application 142 can simulate engine startup and shutdown sequences using RPM sensors 128. In response to RPM sensor 128 falling below a threshold indicated by lookup tables 118, audio enhancement application 142 simulates ignition events or shutdown transitions, by playing sound files 116 corresponding to starter motor cranks, idle stabilization tones, and throttle-off sequences.

In some embodiments, audio enhancement application 142 can identify uneven pavement noise through frequency analysis of road surface vibrations captured by microphone 124. In response to detecting high-frequency texture patterns or impact noise, audio enhancement application 142 cancels ambient pavement noise and injects simulated sound files 116 for tire squeal or gravel interaction, aligned with data from speed sensors 126 and suspension response metrics from accelerometers 130.

In some embodiments, audio enhancement application 142 can detect external transient sounds such as passing vehicles or sirens using microphone 124. In response to identifying these external audio events, audio enhancement application 142 filters transient noise and maintains uninterrupted playback of engine simulation sounds from sound files 116 to preserve immersion.

To select a soundscape using audio enhancement application 142, the user interacts with user interface 160 to select a sound profile or soundscape for audio enhancement application 142 to simulate. In one example, the selection includes selection of a soundscape associated with a second vehicle that is different from a first vehicle in which the audio enhancement application 142 is executed. For example, the second vehicle could include an internal combustion engine vehicle, while the first vehicle is an electric vehicle with an electric powertrain. As another example, the second vehicle could include a vehicle that has a different powertrain than the first vehicle. For example, the second vehicle that is being simulated could be equipped with a louder or more aggressive powertrain than the first vehicle. The selection can further include presets, user-configured profiles, or factory presets associated with specific combustion vehicles. In an initial state where the vehicle is stationary, audio enhancement application 142 uses sensor inputs 120 detect an idle condition. Audio enhancement application 142 uses speed sensors 126, RPM sensors 128, and accelerometers 130 to confirm the lack of forward motion, engine revolutions at idle, and the absence of acceleration forces. Audio enhancement application 142 transmits sensor data to computing device 110, where audio enhancement application 142 interprets the inputs and determines that the vehicle is idling. Based on this condition, audio enhancement application 142 retrieves from memory 114 the sound files 116 corresponding to an idling combustion engine associated with the selected vehicle profile. Audio enhancement application 142 transmits the sound files 116 to speakers 140 for playback within the cabin.

As the user initiates acceleration, audio enhancement application 142 detects the increase in movement using sensor inputs 120. Acceleration data is captured by accelerometers 130, increased RPM values are measured by RPM sensors 128, and speed sensors 126 reflect the increasing vehicle velocity. Audio enhancement application 142 also considers additional environmental factors, including road surface type, incline, and wind speed, as detected by other sensors.

Audio enhancement application 142 can use a variety of different sensor inputs 120 to determine the current operating state of the vehicle simulation. Lookup tables 118 contain threshold values associated with different vehicle behaviors. When the combination of sensor inputs 120 indicates sufficient acceleration, audio enhancement application 142 matches the sensor data to lookup table 118 parameters. This mapping identifies the corresponding sound files 116 to simulate acceleration events, gear shifts, or changes in engine load. Audio enhancement application 142 then plays the appropriate sound files 116 through speakers 140, and audio enhancement application 142 activates seat shakers 150 if the simulation calls for physical vibration.

In some embodiments, physical characteristics of the vehicle cabin such as cabin volume, seat configuration, carpet density, door trim material, cabin size, cabin shape, and other interior features can significantly influence the acoustic experience of the simulated soundscape. Audio enhancement application 142 can account for variations in physical characteristics of the vehicle by adjusting spatial rendering parameters, frequency response, and reverberation profiles. For example, in one embodiment, audio enhancement application 142 can simulate an open-roof configuration corresponding to a convertible vehicle. The cabin is then treated as having an effectively infinite acoustic space, and audio enhancement application 142 appropriately modifies sound propagation and reflection characteristics. This configuration enables the perception of external sounds such as music or speech from an occupant, to persist or blend with the soundscape within the simulated vehicle interior.

In some embodiments, audio enhancement application 142 can incorporate active noise cancellation techniques such as road noise cancellation (RNC) and engine order cancellation (EOC) to suppress undesirable in-cabin noise within the non-simulated vehicle environment. RNC can receive input from accelerometers 130 mounted on the chassis and suspension to detect road-induced vibrations, while EOC can utilize engine RPM sensors 128 to target harmonic frequencies generated by engine operation. Both systems can generate anti-noise signals that are emitted through speakers 140 and monitored using microphones 124. These techniques can be used to eliminate background noise that may interfere with or compromise the simulated soundscape generated by audio enhancement application 142, improving the clarity of the simulated acoustic environment.

As the vehicle traverses different terrain types, navigates turns, and accelerates or decelerates, audio enhancement application 142 interprets sensor data, retrieves associated sound or vibration outputs, modifies sound or vibration outputs as needed, and renders the simulation of the soundscape dynamically. Furthermore, environmental variables such as wind or rain are detected by sensors 120 and microphone 124. Audio enhancement application 142 adapts the simulation in real time and can apply noise-cancellation using microphone 124 and speakers 140 to suppress undesirable exterior sound. Audio enhancement application 142 then spatially renders the adapted soundscape through speakers 140 based on the physical speaker location or a location relative to an occupant of the vehicle.

Speakers 140 are positioned in multiple locations throughout the cabin to enable targeted sound generation from specific positions as needed. For example, speakers 140 can be installed in the front seating area, rear seating area, within headrests, beneath seats, adjacent to left and right doors, or any other technically feasible location in the vehicle environment required to create spatial sound effects. Placement of speakers 140 allows simulation of directionally accurate audio that corresponds to vehicle behavior or other spatial audio requirements. In some implementations, speakers 140 include one or more center channel speakers, left channel speakers, right channel speakers, overhead presence speakers, and upward-directed speakers. The spatial groupings of speakers 140 can enable audio to be mapped accurately to corresponding speakers 140 based on the physical locations of speakers 140. Speakers 140 can also be grouped according to location within the cabin to support audio system configuration and targeted sound rendering strategies.

Seat shakers 150 can be attached to seating or other vehicle components within the vehicle. Seat shakers 150 cause vibration of a seat or other vehicle component in response to a signal from audio enhancement application 142. Audio enhancement application 142 simulates vibrational effects by activating seat shakers 150. Audio enhancement application 142 generates vibrations in seat shakers 150 corresponding to real or simulated mechanical feedback associated with vehicle operation. Examples include vibrations produced during vehicle acceleration associated with a simulated soundscape, simulated gear shifts associated with the simulated soundscape, travel over uneven or bumpy roads, or other high-intensity driving conditions. Additional examples include vehicle vibrations associated with hard braking, rapid deceleration, engine startup, or engine revving. Seat shakers 150 are not limited to the aforementioned examples and can be activated in response to any vibrational event simulated by audio enhancement application 142.

User interface 160 includes any hardware and input configuration that enables interaction with computing device 110. Examples of user interface 160 include touchscreens, rotary knobs, dials, physical buttons, keyboards, pen-and-touch systems, joysticks, sliders, gesture-based controls, capacitive sensors, haptic touchpads, voice command input systems, and motion-sensing controllers. User interface 160 also includes associated output components such as visual displays and auditory feedback mechanisms. Display examples include LCD panels, OLED screens, e-ink displays, segmented LED displays, projection-based displays, and heads-up displays (HUDs). Auditory feedback can be provided through synthesized voice output, tone indicators, or pre-recorded prompts confirming user selections. User interface 160 also includes any additional user-interaction mechanism that is technically feasible and capable of communicating selection input to computing device 110.

User interface 160 allows selection of a specific soundscape to simulate. For example, rotating a dial to a new position can trigger user interface 160 to output an audio confirmation indicating the selected combustion vehicle profile. Similarly, touchscreen interaction can display selectable vehicle modes, and a haptic pulse or audible signal confirms the selection of the user.

By interacting with user interface 160, the user navigates through pre-configured soundscapes associated with combustion vehicles and selects a desired soundscape to simulate. In addition to selecting complete vehicle profiles, user interface 160 enables the user to customize and modify individual elements within a soundscape. For example, user interface 160 can enable the user to remove seat vibrational output, adjust spatial audio balance, deactivate specific speakers 140, or suppress low-frequency engine components. Additional examples include changing engine tone characteristics such as a turbocharger whine intensity, modifying gearshift sound aggressiveness, enabling or disabling simulated environmental sounds such as tire friction or wind noise, and selecting different vehicle behavior profiles (e.g. city driving, highway cruising, or off-road simulation).

User interface 160 also enables saving customized configurations, applying presets associated with different driving conditions, adjusting audio volume levels independently for each sound component, and applying filters that match individual user preferences. User interface 160 supports any technically feasible interaction that enables the user to personalize or control soundscape playback.

User interface 160 can further enable an adjustment of various parameters that define characteristics of the simulated soundscape. For example, parameters adjustable through user interface 160 can include the perceived loudness of tire noise, exhaust sound, engine sound, gear shift intensity, and aerodynamic noise. In addition, user interface 160 can allow a selection or toggling of simulated interior materials, such as switching from leather to fabric seating surfaces, which alters the acoustic absorption and reverberate on properties within the vehicle cabin. User interface 160 can also provide controls for virtual structural elements such as a convertible roof or sunroof, which when are opened, simulate increased cabin openness and modify sound propagation accordingly. For example, opening a window on the same side as a simulated exhaust can increase the perceived exhaust sound level within the cabin.

### Generating Soundscapes

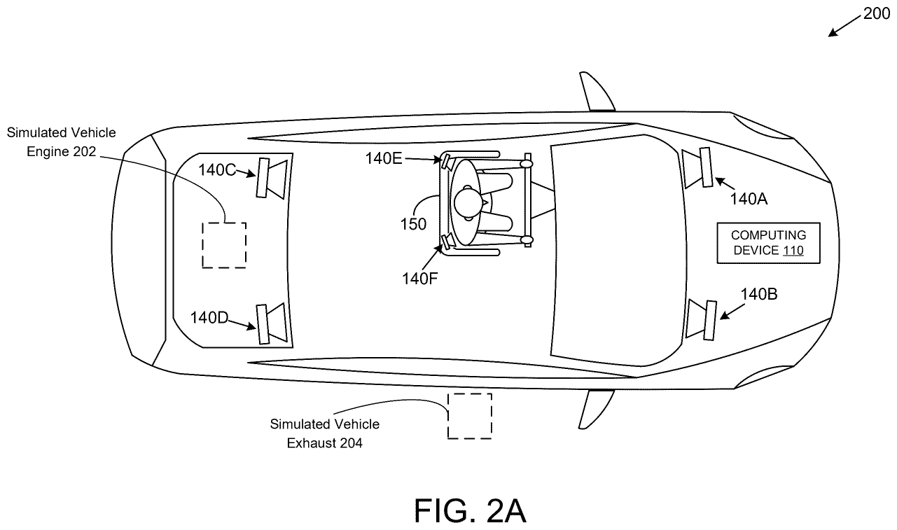

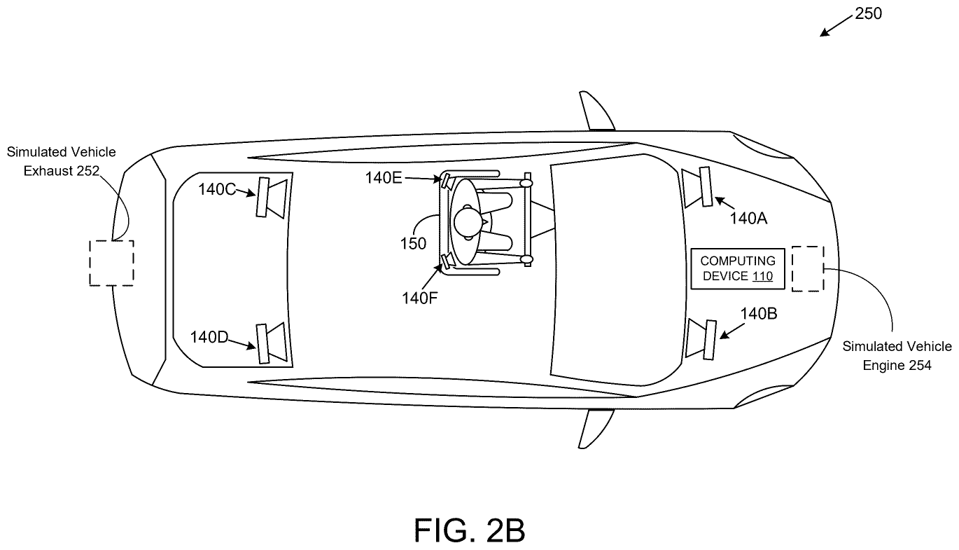

FIG. 2A illustrates an example of a combustion vehicle soundscape according to various embodiments. As shown, a vehicle 200 includes, without limitation, computing device 110, speakers 140, and seat shakers 150. Vehicle 200 further includes simulated vehicle engine 202 and simulated vehicle exhaust 204. Simulated vehicle engine 202 is positioned at the rear of the vehicle, and simulated vehicle exhaust 204 is attached to the right side of the vehicle. This configuration corresponds to a typical layout of an internal combustion engine vehicle featuring a rear-mounted engine and lateral exhaust system. Alternatively, audio enhancement application 142 can generate an object-based audio representation logically positioned at the locations of simulated vehicle engine 202 and simulated vehicle exhaust 204. The object-based audio is rendered using spatial audio techniques to produce directional sound perception based on speaker layout and listener position.

When audio enhancement application 142 simulates sound originating from simulated vehicle exhaust 204, audio enhancement application activates speakers 140D and 140B. Audio enhancement application 142 can activate speaker 140F to reproduce high-frequency noise components when required. When simulating engine sounds, audio enhancement application 142 activates speakers 140C and 140D in unison to create the perception that simulated vehicle engine 202 is located between speakers 140C and 140D. Simulated vehicle exhaust 204 is spatially represented between speakers 140D and 140B. Volume levels of the respective speakers can be adjusted to reflect the relative position of the exhaust. For example, if simulated vehicle exhaust 204 is closer to speaker 140D, speaker 140D outputs at a slightly higher volume relative to speaker 140B to reflect spatial positioning. The speaker arrangement is provided as one example. Audio enhancement application 142 and system 100 can be configured to operate with any technically feasible speaker layout within the cabin of a vehicle. Alternatively, instead of activating specific speakers, audio enhancement application 142 can generate object-based sound sources for the simulated vehicle engine 202 and simulated vehicle exhaust 204. The object-based sound sources can be dynamically mapped to speaker output using spatial audio rendering frameworks such as audio object metadata and listener-relative positioning.

FIG. 2B illustrates an example of a combustion vehicle soundscape according to various embodiments. The vehicle includes computing device 110, speakers 140, and seat shakers 150. Diagram 250 further includes simulated vehicle exhaust 252 and simulated vehicle engine 254. Simulated vehicle engine 254 is positioned at the front of the vehicle, and simulated vehicle exhaust 252 is located at the rear of the vehicle. This configuration corresponds to a typical layout of an internal combustion engine vehicle featuring a front-mounted engine and rear-mounted exhaust system. In one implementation, audio enhancement application 142 generates object-based audio sources corresponding to simulated vehicle engine 254 and simulated vehicle exhaust 252 and renders them using spatial audio algorithms to accurately represent their perceived positions within the cabin environment.

When audio enhancement application 142 simulates sound originating from simulated vehicle exhaust 252, audio enhancement application 142 activates speakers 140C and 140D. Audio enhancement application 142 uses speakers 140F speaker 140E to reproduce high-frequency noise components when required. When simulating engine sounds, audio enhancement application 142 activates speakers 140A and 140B in unison to create the perception that simulated vehicle engine 254 is located between speakers 140A and 140B. The speaker arrangement is provided as one example. Audio enhancement application 142 and system 100 can be configured to operate with any technically feasible speaker layout within the cabin of a vehicle. Alternatively, object-based audio techniques are used to define engine and exhaust sound sources as discrete audio objects. These objects are rendered through speakers 140 using spatial audio processing to create accurate positional audio effects regardless of specific speaker configuration.

### Rendering Vehicle Sounds in a Vehicle Interior

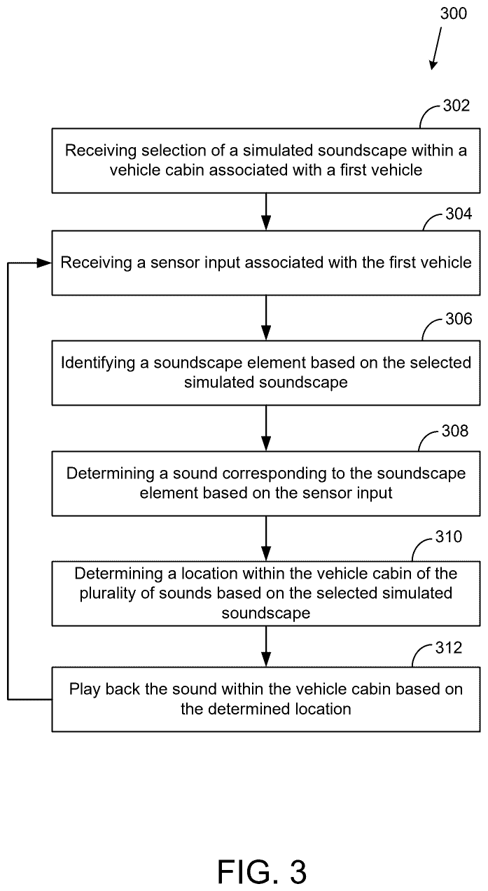

FIG. 3 is a flow diagram of method steps for spatial audio rendering of vehicle sounds in a vehicle interior according to various embodiments. Although the method steps are described with reference to the embodiments of FIG. 1, 2A and 2B, persons skilled in the art will understand that any system configured to implement the method steps, in any order, falls within the scope of the present disclosure.

As shown, a method 300 begins at a step 302, where audio enhancement application 142 receives a selection of a simulated soundscape within a vehicle cabin associated with a first vehicle. As noted above, audio enhancement application 142 receives the soundscape selection via input provided through user interface 160. The selected soundscape can include, but is not limited to, a specific internal combustion engine vehicle soundscape, a particular operational mode of the vehicle (e.g. sport, eco, or comfort), and one or more user-customized parameters. User-customized parameters can include adjustments to vibration intensity, spatial sound emphasis, and frequency shaping.

At a step 304, audio enhancement application 142 receives sensor inputs associated with the first vehicle. Audio enhancement application 142 can receive multiple sensor inputs simultaneously. The sensor input can include any technically feasible input as described as one or more sensor inputs 120. Audio enhancement application 142 compares the received sensor input to predefined thresholds or stored values from lookup tables 118. Additionally, audio enhancement application 142 can compare the sensor input with previously received values to evaluate temporal changes in vehicle dynamics.

At a step 306, audio enhancement application 142 identifies a soundscape element based on the selected simulated soundscape. The soundscape element corresponds to a specific acoustic component or behavior commonly associated with an internal combustion engine vehicle. Example soundscape elements can include engine sounds, acceleration or deceleration noises, gear shift sounds, exhaust resonance, tire-road interaction, vehicle vibrations, or other soundscape elements discussed above. Audio enhancement application 142 determines the relevant soundscape element using the selected vehicle profile, driving mode, and user-defined parameters received via user interface 160 in step 302. The selected soundscape element forms the basis for determining the specific sound to be generated in response to current vehicle conditions.

At a step 308, audio enhancement application 142 determines a sound corresponding to the soundscape element based on the sensor input received in step 304. Audio enhancement application 142 evaluates real-time data from one or more sensor inputs 120 and/or other sensors and maps the sensor data or combination of sensor data to specific sound files 116 using lookup tables 118. For example, if the identified soundscape element is a gear shift, audio enhancement application 142 can select a specific gear change sound from sound files 116 that matches the current RPM and acceleration data. Audio enhancement application 142 can account for both instantaneous sensor values and temporal trends in the data, enabling contextually accurate soundscapes.

At a step 310, audio enhancement application 142 determines a location within the vehicle cabin of the plurality of sounds based on the selected vehicle soundscape or soundscape element. Audio enhancement application 142 determines the location based on the selected simulated soundscape, the nature of the soundscape sensor data to calculate real-time positioning of the sound source within the simulated environment. Audio enhancement application 142 also considers temporal variations in sensor inputs. Spatial metadata can also be defined using object-based audio frameworks to represent logical sound positions within the cabin regardless of physical speaker layout.

At step a 312, audio enhancement application 142 plays back the selected sound within the vehicle cabin at the location determined in step 310. Playback is executed through speakers 140 and, where applicable, seat shakers 150, using volume levels, tonal adjustments, and spatial rendering techniques based on sensor input and user settings. Audio enhancement application 142 adjusts playback characteristics using data from sensors inputs 120 and other sensors.

Audio enhancement application 142 then returns to step 304 from step 312. While audio enhancement application 142 plays sound within the cabin, the system continues to receive updated sensor inputs in accordance with step 304. Audio enhancement application 142 can execute steps 304 through 312 in parallel and in real time following the initial soundscape selection in step 302. Audio enhancement application 142 continuously receives sensor data, identifies the relevant soundscape element, determines a corresponding sound, determines the appropriate playback location, and plays back the output. The cycle ensures that the simulated soundscape remains synchronized with the dynamic behavior and environmental conditions of the vehicle.

In sum, a system enables the selection of a combustion engine vehicle soundscape to mimic and allows for the customization of specific audio attributes within the soundscape. Through a user interface, a user can interact with the system to select the desired soundscape. The system receives a variety of sensor inputs from the vehicle and transmits them to a computing device. The computing device processes the inputs and uses associated sound files stored in memory to recreate the soundscape of the selected combustion vehicle. The system also uses specific lookup tables for sound recreation, and modifies the sound files in real time as needed, depending on the speed, acceleration, RPM, environmental factors, etc. The recreated soundscape is output through vehicle speakers and seat shakers. The system can spatially distribute sounds through specific speakers to generate directionally accurate audio, enhancing the realism of the recreated soundscape.

At least one technical advantage of the disclosed techniques, relative to the prior art, is that the disclosed techniques provide a more realistic soundscape that recreates the various sounds generated by a combustion engine vehicle. The disclosed techniques further account for the directional and positional differences in the soundscape in different parts of a vehicle cabin.

In addition, the disclosed techniques enable the user to interact with a user interface and select a preconfigured soundscape that mimics the experience of driving different combustion engine vehicles. The disclosed techniques also allow for the type of combustion engine vehicle to simulate to be dynamically changed, allowing the user to selectively control which type of combustion engine vehicle to mimic. Another technical advantage of the disclosed techniques is the ability to customize the soundscape to allow specific audio attributes to be selectively enhanced, reduced, or removed entirely, thereby tailoring the audio output to the desired experience of the user. These technical advantages provide one or more technological improvements over prior art approaches.

1. In some embodiments, a computer-implemented method for reproducing a simulated soundscape within a first vehicle comprises receiving selection of the simulated soundscape within a vehicle cabin associated with the first vehicle, receiving a sensor input associated with the first vehicle, identifying a soundscape element based on the selected simulated soundscape, determining a sound corresponding to the soundscape element based on the sensor input, determining a location within the vehicle cabin of the sound based on the selected simulated soundscape, and causing playback of the sound within the vehicle cabin based on the location.

2. The computer-implemented method of clause 1, wherein the simulated soundscape comprises a soundscape associated with a second vehicle that is different from the first vehicle.

3. The computer-implemented method of clauses 1 or 2, wherein the second vehicle comprises a different powertrain than the first vehicle.

4. The computer-implemented method of any of clauses 1-3, wherein the first vehicle comprises an electric powertrain and the simulated soundscape is associated with a combustion engine powertrain.

5. The computer-implemented method of any of clauses 1-4, wherein the sensor input is associated with vehicle motion or vehicle acceleration of the first vehicle.

6. The computer-implemented method of any of clauses 1-5, wherein the sensor input comprises a revolutions-per-minute (RPM) of one or more wheels of the first vehicle or a motor associated with the first vehicle.

7. The computer-implemented method of any of clauses 1-6, wherein determining the sound corresponding to the soundscape element further comprises determining a degree of vehicle motion or vehicle acceleration, and selecting the sound from a library of sounds associated with the selected simulated soundscape based on the degree or vehicle motion or vehicle acceleration.

8. The computer-implemented method of any of clauses 1-7, wherein the sound comprises an engine sound, a sound caused by engagement with a road, or a transmission sound associated with a second vehicle.

9. The computer-implemented method of any of clauses 1-8, further comprising causing vibration of a vehicle component based upon the sensor input.

10. The computer-implemented method of any of clauses 1-9, wherein the vehicle component comprises one or more seats within the first vehicle.

11. The computer-implemented method of any of clauses 1-10, wherein determining the location within the vehicle cabin of the sound based on the selected simulated soundscape comprises determining a location of a simulated vehicle sound relative to one or more occupants of the first vehicle.

12. The computer-implemented method of any of clauses 1-11, wherein causing playback of the sound comprises causing the simulated vehicle sound to be played back by one or more speakers associated with the vehicle from a direction associated with the location of the simulated vehicle sound.

13. In some embodiments, one or more non-transitory computer-readable media store instructions for reproducing a simulated soundscape within a first vehicle that, when executed by one or more processors, cause the one or more processors to perform the steps of receiving selection of the simulated soundscape within a vehicle cabin associated with the first vehicle, receiving a sensor input associated with the first vehicle, identifying a soundscape element based on the selected simulated soundscape, determining a sound corresponding to the soundscape element based on the sensor input, determining a location within the vehicle cabin of the sound based on the selected simulated soundscape, and causing playback of the sound within the vehicle cabin based on the location.

14. The one or more non-transitory computer-readable media of clause 13, wherein the simulated soundscape comprises a soundscape associated with a second vehicle that has a different powertrain than the first vehicle.

15. The one or more non-transitory computer-readable media of clauses 13 or 14, wherein the first vehicle comprises an electric powertrain and the simulated soundscape is associated with a combustion engine powertrain.

16. The one or more non-transitory computer-readable media of any of clauses 13-15, wherein the sensor input is associated with vehicle motion or vehicle acceleration of the first vehicle.

17. The one or more non-transitory computer-readable media of any of clauses 13-16, wherein the sound comprises an engine sound, a sound caused by engagement with a road, or a transmission sound associated with a second vehicle

18. The one or more non-transitory computer-readable media of any of clauses 13-17, further comprising causing vibration of a vehicle component based upon the sensor input, wherein the vibration is caused by activating a seat shaker within a seat within the first vehicle.

19. The one or more non-transitory computer-readable media of any of clauses 13-18, wherein the simulated soundscape includes an exhaust sound associated with a combustion engine powertrain.

20. In some embodiments, a system comprises a memory storing instructions for an audio enhancement application, and a processor coupled to the memory that implements the audio enhancement application by performing the steps of receiving selection of a simulated soundscape within a vehicle cabin associated with a first vehicle, receiving a sensor input associated with the first vehicle, identifying a soundscape element based on the selected simulated soundscape, determining a sound corresponding to the soundscape element based on the sensor input, determining a location within the vehicle cabin of the sound based on the selected simulated soundscape, and causing playback of the sound within the vehicle cabin based on the location.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reproducing a simulated soundscape within a first vehicle, the method comprising:
receiving selection of the simulated soundscape within a vehicle cabin associated with the first vehicle;
receiving a sensor input associated with the first vehicle;
identifying a soundscape element based on the selected simulated soundscape;
determining a sound corresponding to the soundscape element based on the sensor input;
determining a location within the vehicle cabin of the sound based on the selected simulated soundscape; and
causing playback of the sound within the vehicle cabin based on the location.

2. The computer-implemented method of claim 1, wherein the simulated soundscape comprises a soundscape associated with a second vehicle that is different from the first vehicle.

3. The computer-implemented method of claim 2, wherein the second vehicle comprises a different powertrain than the first vehicle.

4. The computer-implemented method of claim 1, wherein the first vehicle comprises an electric powertrain and the simulated soundscape is associated with a combustion engine powertrain.

5. The computer-implemented method of claim 1, wherein the sensor input is associated with vehicle motion or vehicle acceleration of the first vehicle.

6. The computer-implemented method of claim 5, wherein the sensor input comprises a revolutions-per-minute (RPM) of one or more wheels of the first vehicle or a motor associated with the first vehicle.

7. The computer-implemented method of claim 5, wherein determining the sound corresponding to the soundscape element further comprises:
determining a degree of vehicle motion or vehicle acceleration; and
selecting the sound from a library of sounds associated with the selected simulated soundscape based on the degree or vehicle motion or vehicle acceleration.

8. The computer-implemented method of claim 1, wherein the sound comprises an engine sound, a sound caused by engagement with a road, or a transmission sound associated with a second vehicle.

9. The computer-implemented method of claim 1, further comprising causing vibration of a vehicle component based upon the sensor input.

10. The computer-implemented method of claim 9, wherein the vehicle component comprises one or more seats within the first vehicle.

11. The computer-implemented method of claim 1, wherein determining the location within the vehicle cabin of the sound based on the selected simulated soundscape comprises determining a location of a simulated vehicle sound relative to one or more occupants of the first vehicle.

12. The computer-implemented method of claim 10, wherein causing playback of the sound comprises causing the simulated vehicle sound to be played back by one or more speakers associated with the vehicle from a direction associated with the location of the simulated vehicle sound.

13. One or more non-transitory computer-readable media storing instructions for reproducing a simulated soundscape within a first vehicle that, when executed by one or more processors, cause the one or more processors to perform the steps of:
receiving selection of the simulated soundscape within a vehicle cabin associated with the first vehicle;
receiving a sensor input associated with the first vehicle;
identifying a soundscape element based on the selected simulated soundscape;
determining a sound corresponding to the soundscape element based on the sensor input;
determining a location within the vehicle cabin of the sound based on the selected simulated soundscape; and
causing playback of the sound within the vehicle cabin based on the location.

14. The one or more non-transitory computer-readable media of claim 13, wherein the simulated soundscape comprises a soundscape associated with a second vehicle that has a different powertrain than the first vehicle.

15. The one or more non-transitory computer-readable media of claim 13, wherein the first vehicle comprises an electric powertrain and the simulated soundscape is associated with a combustion engine powertrain.

16. The one or more non-transitory computer-readable media of claim 13, wherein the sensor input is associated with vehicle motion or vehicle acceleration of the first vehicle.

17. The one or more non-transitory computer-readable media of claim 13, wherein the sound comprises an engine sound, a sound caused by engagement with a road, or a transmission sound associated with a second vehicle.

18. The one or more non-transitory computer-readable media of claim 13, further comprising causing vibration of a vehicle component based upon the sensor input, wherein the vibration is caused by activating a seat shaker within a seat within the first vehicle.

19. The one or more non-transitory computer-readable media of claim 13, wherein the simulated soundscape includes an exhaust sound associated with a combustion engine powertrain.

20. A system comprising:
a memory storing instructions for an audio enhancement application; and
a processor coupled to the memory that implements the audio enhancement application by performing the steps of:
receiving selection of a simulated soundscape within a vehicle cabin associated with a first vehicle;
receiving a sensor input associated with the first vehicle;
identifying a soundscape element based on the selected simulated soundscape;
determining a sound corresponding to the soundscape element based on the sensor input;
determining a location within the vehicle cabin of the sound based on the selected simulated soundscape; and
causing playback of the sound within the vehicle cabin based on the location.
